(19) United States
(12) Patent Application Publication
(10) Pub. No.: US 2018/0114191 A1
(43) Pub. Date: Apr. 26, 2018

(54) Custom Test Systems for Leveraging Centrally Located Subject Matter Expert Recommendations in Personnel Selection

(71) Applicant: UTI Limited Partnership, Calgary (CA)

(72) Inventor: Piers David Gareth Steel, Calgary (CA)

(73) Assignee: UTI Limited Partnership, Calgary (CA)

(21) Appl. No.: 15/793,855

(22) Filed: Oct. 25, 2017

Related U.S. Application Data
(60) Provisional application No. 62/412,724, filed on Oct. 25, 2016.

(51) Int. Cl. G06Q 10/10; G06Q 10/04; G06Q 10/06; G06F 3/048; G06F 17/15

(52) U.S. Cl. CPC G06Q 10/1053; G06Q 10/04; G06F 17/15; G06Q 10/0637; G06F 3/048; G06Q 10/0639

(57) ABSTRACT

Embodiments of custom test systems for leveraging centrally located subject matter expert recommendations in personnel selection are presented. In an embodiment, a method includes storing a predetermined set of personnel tests in a database. The method may also include determining a correlation indicator, the correlation indicator defining a strength of correlation between an aspect of at least one of the personnel tests and a measure of job performance, wherein the correlation indicator is determined in response to validation information provided by one or more subject matter experts. Additionally, such a method may include automatically building a custom personnel evaluation in response to the correlation indicator.

### CROSS-REFERENCE TO RELATED APPLICATIONS

This application claims priority to U.S. Provisional Pat. App. No. 62/412,724 entitled “custom test systems for leveraging centrally located subject matter expert recommendations in personnel selection,” which was filed on Oct. 25, 2016.

### FIELD

This disclosure relates generally to human resource management systems, and more specifically, to custom test systems for leveraging centrally located subject matter expert recommendations in personnel selection.

### BACKGROUND

Employers use pre-employment tests to evaluate job applicants in order to make better selection decisions. To build a pre-employment test for a job, employers may conduct a job analysis to identify human characteristics (such as cognitive abilities and work styles) critical to effective job performance. Interviews help to identify human characteristics, which are also called predictors as they can predict the future job performance. Employers may also purchase or build pre-employment tests that measure each of these human characteristics, or predictors. Employers can validate each predictor by administering a test that assesses the predictor to employees, collect their job performance data (e.g., supervisory occupation performance ratings), and identify meaningful correlation between test scores and job performance scores (with ideally 100 or more employees, to be statistically accurate).

When building and/or using pre-employment test systems, employers generally abide by the Equal Employment Opportunity Commission's (EEOC) Uniform Guidelines on Employee Selection Procedures (“Uniform Guidelines”). The Uniform Guidelines tell us that job analysis and validation research, whether content oriented, criterion-related, or construct validity-based, are always needed prior to using a test in a new location, if the test has the potential to cause adverse impact, defined as “a substantially different rate of selection in hiring, promotion, or other employment decision which works to the disadvantage of members of a race, sex, or ethnic group” (Uniform Guidelines on Employee Selection Procedures, 1978). Cognitive ability tests are frequently used in selection because they are one of the most predictive tests of occupation performance and training success, and cognitive abilities are an employee requirement for virtually every job. However, these tests can demonstrate high levels of adverse impact against certain minorities. Therefore, any pre-employment testing system that includes cognitive abilities as predictors must be validated according to the Uniform Guidelines.

Validation, however, faces three roadblocks. The first is that content validation is an inappropriate validation strategy for measures of cognitive abilities. Although the Uniform Guidelines make allowance for alternative validation strategies, such as test transportability, the requirements for transportability are still demanding (namely, the previous validation study must have met all requirements of the Uniform Guidelines). The second roadblock is that validity generalization (VG) researchers using meta-analysis techniques downplay the need for job analysis and local validation studies, but selection-related legal case law demonstrates that occupation analysis is a necessary ingredient for successful defense of selection systems for a review of court cases dealing with occupation analysis). Validity generalization has had an inconsistent track record in court, primarily because of its failure to incorporate detailed job analysis information. The third roadblock is that, although empirical criterion validation strategies can be used for validating cognitive abilities tests against overall job performance, this approach typically requires collecting sample data on test scores and job performance ratings on a minimum of one hundred tested and hired employees. In many situations, especially in jobs where an employer has fewer than a hundred employees working in a single occupation (low-incumbent occupations), this is impossible.

Given these three roadblocks, one challenge for validating pre-employment selection tests of cognitive ability across a wide range of occupations includes challenges of how the validity coefficient of a cognitive (or any other) predictor against overall job performance can be established without the need to collect empirical data, but at the same time leverage job analysis so that we have accuracy and legal defensibility.

Even when employers have a large enough sample size of incumbent employees to criterion-validate a test battery that consists of cognitive and/or workstyles/other predictors, the entire process to build a custom test battery for each job typically takes several months and can be very costly. Additionally, a separate test battery is often created for each job.

Even when employers don't use cognitive abilities in their tests, and use other predictors such as work styles, they typically perform empirical criterion validation for their high-volume jobs. For their low-volume jobs, employers typically don't build tests or when they build tests, they don't criterion validate their tests. Criterion-validation is not required if the tests don't demonstrate adverse impact.

Synthetic validity is a logical process of inferring validity on the basis of the relationships between components of a job and tests of the human characteristics that are needed to perform the job components. The occupational information network (O*NET) database is one primary source of job information. To build a testing system using current synthetic validity approaches would require criterion validity studies—a study where a correlation coefficient is calculated between the test scores and supervisor ratings of overall job performance of a large sample of employees working at an employer in that job—using a standard set of predictors on approximately 690 jobs, with a sample size of at least 50 employees for each job. This would take years, and perhaps decades. One proposed solution involves a distributed approach to building the synthetic validity testing system, using O*NET job components and locally available subject matter experts in personnel selection to provide validity coefficient ratings to local jobs, thereby distributing the burden for building this system across the body of practitioners seeking synthetic validity estimates for their local selection situations. Such an approach is impractical to implement within a reasonable time frame and there are high recruiting and coordination costs. Because of these reasons, until now, an O*NET-based synthetic validity pre-employment testing system has not been built.

### SUMMARY

Embodiments of custom test systems for leveraging centrally located subject matter expert recommendations in personnel selection are presented. In an embodiment, a method includes storing a predetermined set of personnel tests in a database. The method may also include determining a correlation indicator, the correlation indicator defining a strength of correlation between an aspect of at least one of the personnel tests and a measure of job performance, wherein the correlation indicator is determined in response to validation information provided by one or more subject matter experts. Additionally, such a method may include automatically building a custom personnel evaluation in response to the correlation indicator.

An embodiment of a system may include a data storage device configured to store a predetermined set of personnel tests in a database. Additionally, the system may include a data processor coupled to the data storage device. The data processor may be configured to determine a correlation indicator, the correlation indicator defining a strength of correlation between an aspect of at least one of the personnel tests and a measure of job performance, wherein the correlation indicator is determined in response to validation information provided by one or more subject matter experts, and automatically build a custom personnel evaluation in response to the correlation indicator.

Another embodiment of a system is described. In such an embodiment, the system may include a user interface configured to present a prompt for evaluating an aspect of at least one personnel test and job performance. The system may also include a user control for receiving an assignment of a correlation indicator for defining a strength of correlation between the aspect of the at least one personnel test and a measure of job performance. Additionally, the system may include a communication interface for communicating the assignment of the correlation indicator to a database of correlation indicators associated with a predetermined set of one or more personnel tests.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a schematic block diagram illustrating one embodiment of a system for leveraging centrally located subject matter expert recommendations in personnel selection.

FIG. 2 is a logical block diagram illustrating one embodiment of a data architecture for leveraging centrally located subject matter expert recommendations in personnel selection.

FIG. 3 is a schematic block diagram illustrating one embodiment of an Information Handling System (IHS) configured leveraging centrally located subject matter expert recommendations in personnel selection.

FIG. 4 is a logical block diagram illustrating one embodiment of a layered communications system configured for leveraging centrally located subject matter expert recommendations in personnel selection.

FIG. 5 is a schematic flowchart diagram illustrating one embodiment of a method for leveraging centrally located subject matter expert recommendations in personnel selection.

FIG. 6 illustrates an embodiment of a correlation between frequency of a characteristic and validity coefficients.

FIG. 7 is a screenshot diagram illustrating one embodiment of a user interface for collecting SME data.

FIG. 8 shows correlations of validity correlations by job.

### DETAILED DESCRIPTION

Embodiments of custom test systems for leveraging centrally located subject matter expert recommendations in personnel selection. Although there are many tests available for various cognitive abilities and work styles, customization and application of these tests is difficult, expensive and time-consuming. The present embodiments resolve these issues by providing a system and data architecture for collecting correlation information from SMEs, the correlation information indicative of a correlation between test performance and job performance in a specified job. A correlation coefficient may be calculated for each test, the correlation coefficient being calculated in response to correlation information collected from the SMEs. Customized personnel evaluations may be automatically generated in response to selection of a job, and correlation coefficients calculated for each test in association with the job. Additionally, time limits may be factored into the automatic generation of the personnel evaluation.

The present embodiments include methods and systems that for building a synthetic validity system in considerably less time that previous approaches. Such embodiments include a O*NET-based synthetic validity system.

The present embodiments overcome the above challenge specifically for O*NET taxonomy based cognitive abilities (and work styles) by leveraging centrally-located Subject Matter Experts (SMEs) in personnel selection and meta-analysis validity research to theoretically derive the validity for each cognitive (and work style) predictor. Using such an embodiment of a synthetic validated test system, an employer may reduce the time taken to a matter of days as employees only need to perform a light-weight job analysis in order to build a test battery; there is no need to build/buy tests for predictors as they are already bundled into our system and there is no need to make at least 100 employees complete predictor tests and have their supervisors provide job performance ratings. The cost will also be reduced significantly because such a system does not take up the time (which has a cost equivalent) of employees and their supervisors as much as in the traditional method of building a custom test battery for a job.

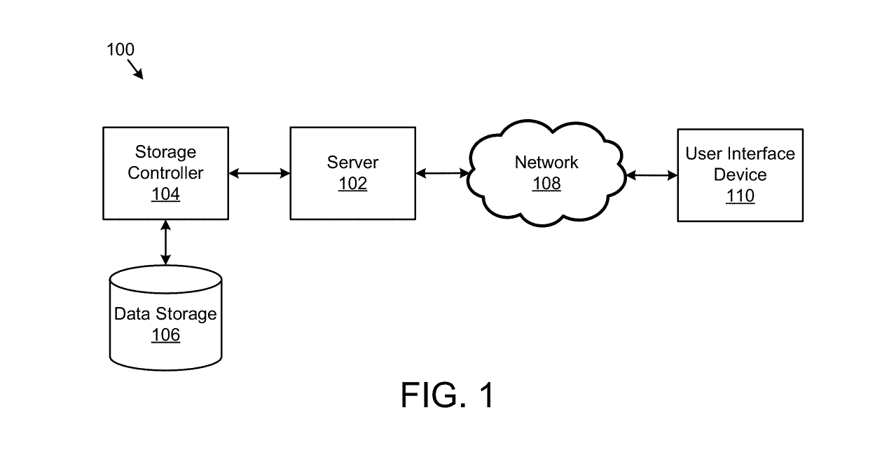

FIG. 1 illustrates one embodiment of a system 100 for leveraging centrally located SME recommendations in personnel selection. The system 100 may include a server 102, a data storage device 104, a network 108, and a user interface device 110. In a further embodiment, the system 100 may include a storage controller 106, or storage server configured to manage data communications between the data storage device 104, and the server 102 or other components in communication with the network 108. In an alternative embodiment, the storage controller 106 may be coupled to the network 108. In a general embodiment, the system 100 may automatically generate personnel evaluations by leveraging a central repository of SME data.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, an employer may enter a job or job category selection, a time limit for the evaluation, or the like. In another embodiment, an SME may enter correlation information by a separate user interface displayed on a user interface device 110. In still another embodiment, an employee or prospective employee may complete the personnel evaluation via a user interface device 110. In such embodiments, the server 102 may communicate user interface data to the user interface device 110 over the network 108 for generating a user interface specific to each function.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

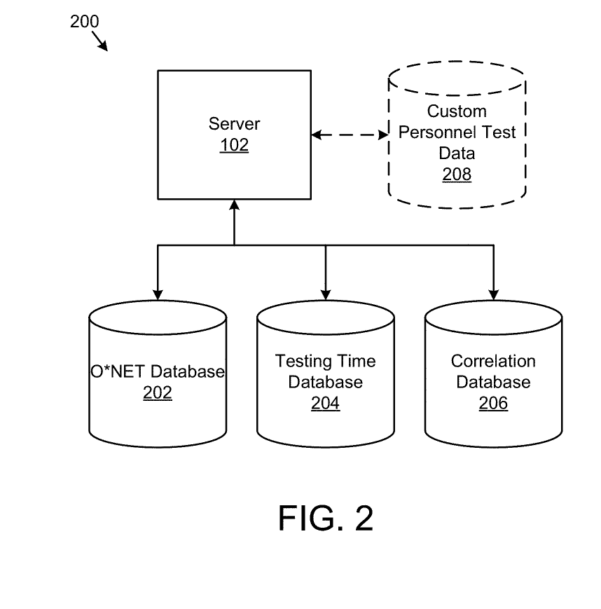

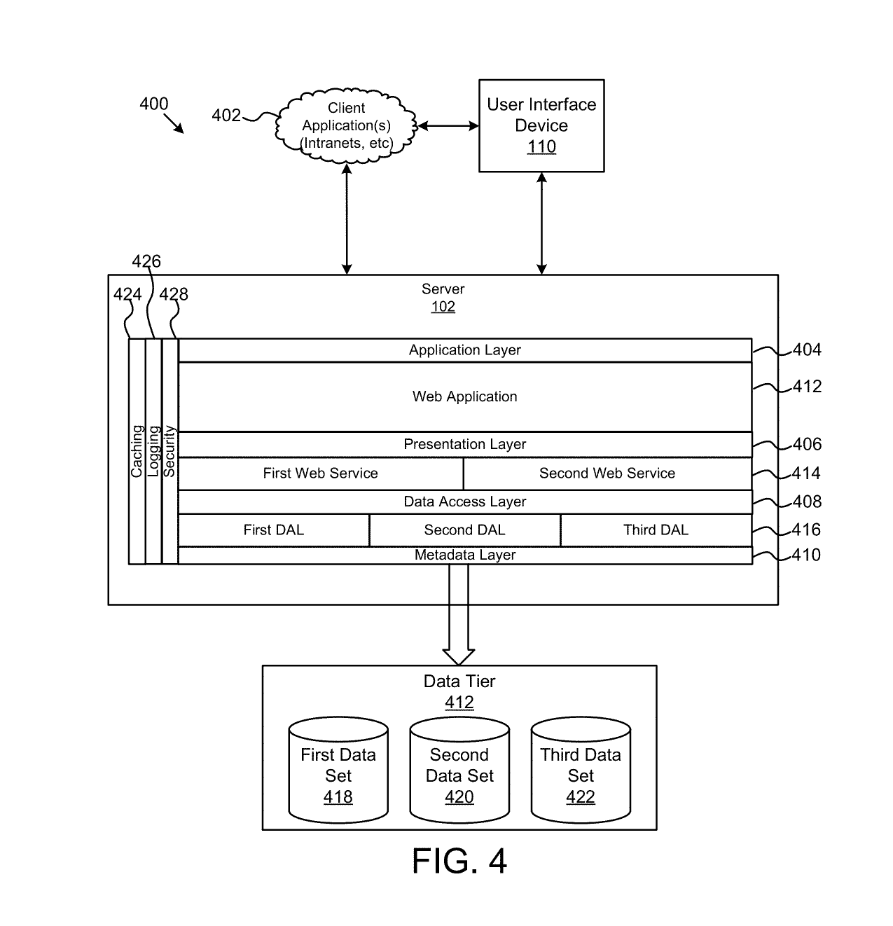

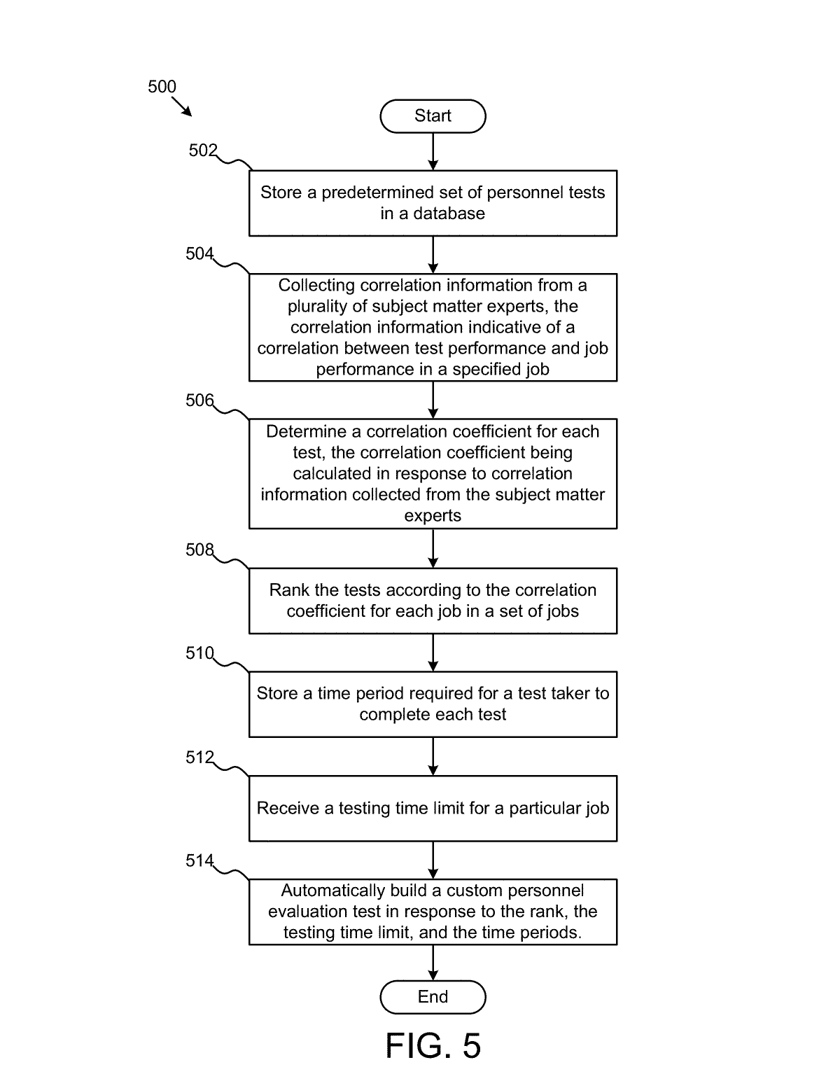

In one embodiment, the server 102 is configured to perform the steps of the method described in the flowchart of FIG. 5. Additionally, the server 102 may access data stored in the data storage device 104 via a Storage Area Network (SAN) connection, a LAN, a data bus, or the like. Further data architectures are described in FIGS. 2 and 4.

The data storage device 104 may include a hard disk, including hard disks arranged in a Redundant Array of Independent Disks (RAID) array, an optical storage device, or the like. In one embodiment, the data storage device 104 may store test data, such as tests from an O*NET test set, correlation data and correlation coefficients, test completion times, and the like. The data may be arranged in a database and accessible through Structured Query Language (SQL) queries, or other data base query languages or operations.

FIG. 2 illustrates one embodiment of a data management system 200 configured to store and manage data for automatically generating personnel evaluations. In one embodiment, the system 200 may include a server 102. The server 102 may be coupled to a data-bus 202. In one embodiment, the system 200 may also include an O*NET database 204, a test completion time database 206 and/or a correlation information database 208. In further embodiments, the system 200 may include additional data storage devices (not shown). In such an embodiment, each database 204-208 may be hosted by the same, or separate, data storage devices. The customer information in each database may be keyed to a common field or identifier, such as a job category, a job identifier (ID), a test ID, or the like. Alternatively, the storage devices 204-208 may be arranged in a RAID configuration for storing redundant copies of the database or databases through either synchronous or asynchronous redundancy updates.

In one embodiment, the server 102 may submit a query to selected databases 204-206 to collect a consolidated set of data elements for generating a custom personnel evaluation. The server 102 may store the custom personnel evaluation data in a customer personnel test database 210. In such an embodiment, the server 102 may refer back to the custom personnel test database 210 to obtain a set of data elements associated with a specified personnel evaluation. Alternatively, the server 102 may query each of the databases 204-208 independently or in a distributed query to obtain the set of data elements associated with a specified individual. In another alternative embodiment, multiple databases may be stored on a single consolidated data storage device.

In various embodiments, the server 102 may communicate with the data storage devices 204-210 over the data-bus 202. The data-bus 202 may comprise a SAN, a LAN, or the like. The communication infrastructure may include Ethernet, Fibre-Channel Arbitrated Loop (FC-AL), Small Computer System Interface (SCSI), and/or other similar data communication schemes associated with data storage and communication. For example, the server 102 may communicate indirectly with the data storage devices 204-210; the server first communicating with a storage server or storage controller 106.

The server 102 may host a software application configured for custom personnel evaluation and test generation. The software application may further include modules for interfacing with the data storage devices 204-210, interfacing a network 108, interfacing with a user, and the like. In a further embodiment, the server 102 may host an engine, application plug-in, or application programming interface (API). In another embodiment, the server 102 may host a web service or web accessible software application.

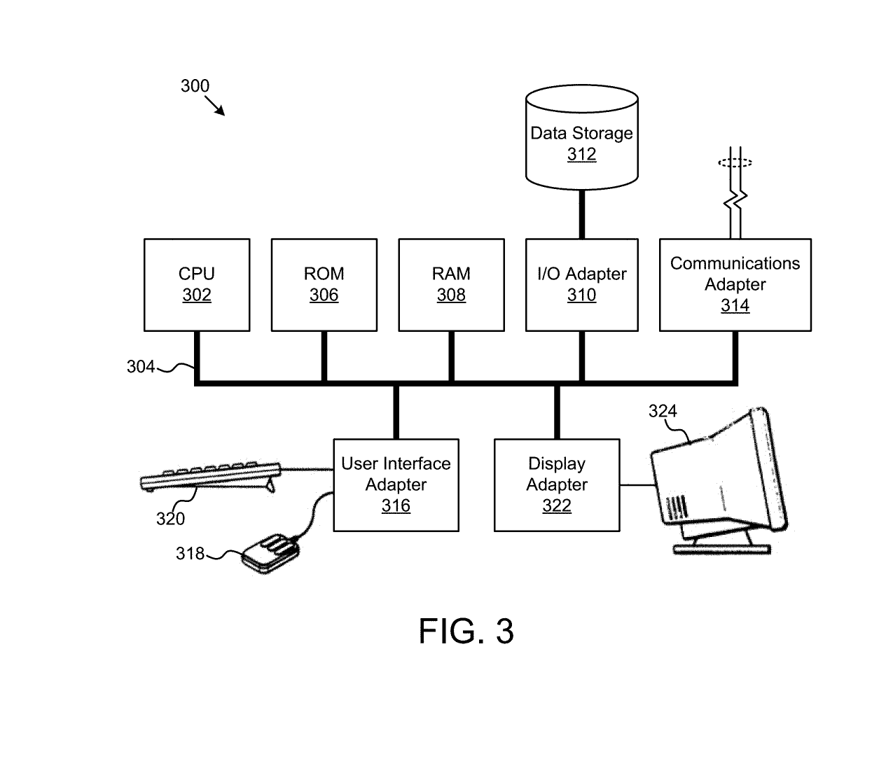

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIG. 5.

The computer system 300 also may include Random Access Memory (RAM) 308, which may be SRAM, DRAM, SDRAM, or the like. The computer system 300 may utilize RAM 308 to store the various data structures used by a software application configured for leveraging centrally located SME recommendations in personnel selection. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information for test data, correlation information, timing information, test generation specifications, jobs or job categories, and evaluation responses. In a further embodiment, the display adapter 322 may display a graphical user interface associated with a software or web-based application for leveraging centrally located SME recommendations in personnel selection.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 106, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

FIG. 4 illustrates one embodiment of a network-based system 400 for leveraging centrally located SME recommendations in personnel selection. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 422-422 that comprise a data layer or data tier 412. For example, a first data set 422, a second data set 420 and a third data set 422 may comprise a data tier 412 that is stored on one or more data storage devices 204-208.

One or more web applications 412 may operate in the application layer 404. For example, a user may interact with the web application 412 though one or more I/O interfaces 318, 320 configured to interface with the web application 412 through an I/O adapter 310 that operates on the application layer. In one particular embodiment, a web application 412 may be provided for leveraging centrally located SME recommendations in personnel selection that includes software modules configured to perform the steps of the methods described in FIG. 5.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on a first server 102 and access one or more web services 414 hosted on a second server (not shown) during operation.

For example, a web application 412 for collecting correlation information from SMEs located at various sites remote from the server 102, and collecting evaluation responses from personnel, or other information may access a first web service 414 for requesting a new custom evaluation to be generated and a second web service 414 for displaying the custom evaluation to an employee or prospective employee over a user interface device 110. The web services 414 may receive evaluation category and time specifications. In response, the web service 414 may return data representative of prompts for a customer personnel evaluation. One of ordinary skill in the art will recognize various web-based architectures employing web services 414 for modular operation of a web application 412.

In one embodiment, a web application 412 or a web service 414 may access one or more of the data sets 418-422 through the data access layer 408. In certain embodiments, the data access layer 408 may be divided into one or more independent data access layers 416 for accessing individual data sets 418-422 in the data tier 412. These individual data access layers 416 may be referred to as data sockets or adapters. The data access layers 416 may utilize metadata from the metadata layer 410 to provide the web application 412 or the web service 414 with specific access to the data set 412.

For example, the data access layer 416 may include operations for performing a query of the data sets 418-422 to retrieve specific information for the web application 412 or the web service 414. In a more specific example, the data access layer 416 may include a query for generating a customer evaluation in response to time and job type specifications.

FIG. 5 is a schematic block diagram illustrating one embodiment of a method 500 for leveraging centrally located SME recommendations in personnel selection. In an embodiment, the method 500 includes storing a predetermined set of personnel tests in a database, as shown at block 502. The method 500 may also include collecting correlation information from a plurality of subject matter experts, the correlation information indicative of a correlation between test performance and job performance in a specified job as shown at block 504. At block 506, the method 500 may include determining a correlation coefficient for each test, the correlation information being calculated in response to the correlation information collected from the subject matter experts. Additionally, the method 500 may include ranking the tests according to the correlation coefficient for each job in the set of jobs, as shown at block 508. The method 500 may also include storing a time period required for a test taker to complete each test, as shown at block 508, and receiving a testing time limit for a particular personnel evaluation test as shown at block 510. The method 500 may further include automatically building a custom personnel evaluation test in response to the rank, the testing time limit, and the time periods as shown at block 514.

In particular, O*NET includes 33 tests—17 for cognitive abilities and 16 for work styles—corresponding to each cognitive ability and work style. The present embodiments may define a correlation coefficient (also called validity coefficient) between each test and the overall job performance for a particular job. Additionally, the present methods may include ranking each of the tests based on their correlation coefficients for a particular job. The time required to complete each test may be determined in advance, and stored in a database. Therefore, based on the overall time limit set by an employer, the present systems may be used to select the most relevant tests, based on their correlation coefficients, such that the employer-set time is filled, but not exceeded.

It is challenging to find the correlation coefficient between any one of our tests and the overall job performance for a particular job? The traditional way of doing this is to make 100+ employees working in that occupation take the test, obtain the overall job performance rating from their supervisors, and then calculate the correlation coefficient. However, this solution is painful and often impractical when an employer has less than 100 employees working in the job.

An embodiment of method may include providing a portal for experts in the field of personnel selection to provide estimates of the correlation coefficient (between test scores and performance ratings) for the job. In an embodiment, an inductive reasoning test may be indicative of a cognitive ability. In such an example, it may be desirable to find the correlation coefficient between inductive reasoning and overall job performance for any job. The correlation coefficient will vary based on the type of job. For example, for occupations such as software developers the correlation coefficient will be high, but whereas for occupations such as truck drivers the correlation coefficient may be low. Through factor analysis of the O*NET database, it is determined that there are 38 job and contextual characteristics falling under the categories of Data, People, Things, Constraints, and Consequences that moderate these validity coefficients.

In an embodiment, the correlation coefficient range, for each test such as inductive reasoning, from past research studies for inductive reasoning may be stored. These studies are combined together (as meta-analytic studies) to find the possible range for inductive reasoning across all jobs. The described embodiments also calculate the mean correlation coefficient for inductive reasoning for all jobs through meta-analytic processing.

SMEs in personnel selection may respond, via the systems described herein, with correlation information, such as whether a job is HIGH on Data by 1 standard deviation from the mean, and how much the correlation coefficient of inductive reasoning with overall job performance would be. Additionally, the SME may describe whether a job is HIGH on People by 1 standard deviation from the mean, and correspondingly, how much the correlation coefficient of inductive reasoning with overall job performance would be, and so on, for all the five job/contextual characteristic categories.

Once experts provide inputs answering these questions, assuming that they are all in a statistically high degree of agreement, the correlation coefficients and rankings are automatically derived. In an embodiment, a statistical precheck process may be performed to identify outliers and automatically request clarification, or automatically remove outliers from the computation. Therefore, in the present example, the system may calculate the correlation coefficient for inductive reasoning for any job once the level ratings (the level of job characteristic) are provided by SMEs through the portal for each of the 38 job characteristics for a job. The same method above applies to every one of the 33 tests.

The disclosed methods and systems provide several benefits and advantages over the previous human resource management methods and systems. For example, the methods do not rely on the empirical approach. This approach would require empirical validity data on around 690 jobs. Additionally, the methods do not rely on the distributed SME approach. This approach would require multiple employer organizations to first adopt a common taxonomy such as O*NET and then provide validity estimates for their local jobs. There is merit to this solution, but it's impractical to implement. Additionally, the present embodiments estimate the validity for any job by allowing a group of centralized SMEs estimate the validity of each predictor with overall job performance for groups of jobs—high on Data, People, Things, Constraints, and Consequences. Additionally, the validity coefficient can be calculated for a job by understanding how high it is on Data, People, Things, Constraints, and Consequences. This can be determined by surveying experienced employees working in a job to provide the level of Data, People, Things, Constraints, and Consequences by rating 39 job characteristics that fall under these 5 job characteristics.

Validity Generalization

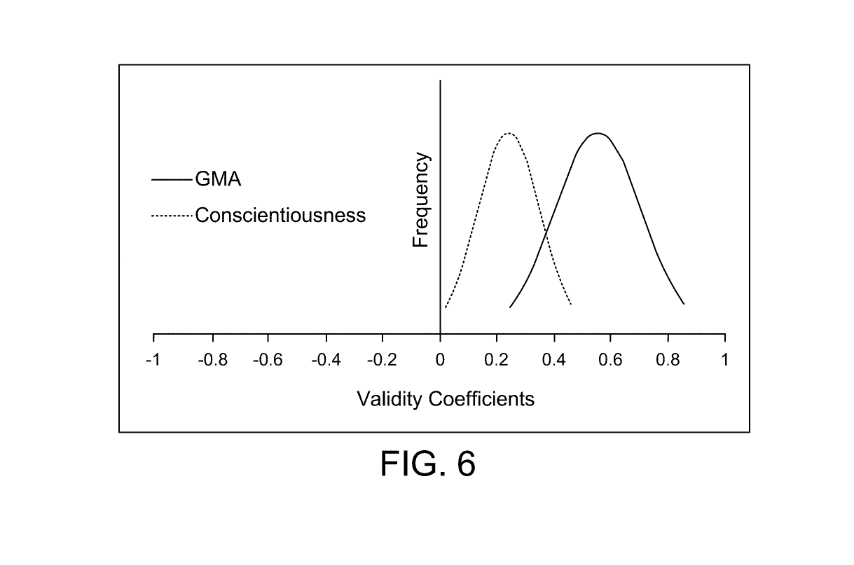

Hiring smart and hardworking employees—and avoiding less-smart and less-hardworking employees—is critically important for employer productivity. While this may seem like common sense, it requires collection of data that explain the degree to which job performance is improved (and organizational value gained) through hiring job applicants measured on their cognitive abilities and work styles. Previously collected validity data are aggregated and analyzed statistically through a meta-analytic process called validity generalization, as shown in FIG. 6. The present embodiments may collect past research examining the associations between predictors and criteria for across hundreds, if not thousands, of occupations. For example, these associations might reflect correlations between conscientiousness and performance, and general mental ability (intelligence) and performance. Once controlled for statistical imprecision (sampling error variance) due to studies with smaller sample sizes, validity generalization results tend to be one of the best supported empirical findings in all of psychology.

Although there aren't exact single values for the correlations (there are still some random-effects variance, even after controlling for sampling error variance, as per the figure above), it has been determined that these correlations are all positive—high levels of general mental ability and conscientious are good thing. Better yet, the amount of uncertainty in estimation is far lower than most selection systems already in use. This is similar to how Bayesian analyses can provide more conservative and more stable estimates by borrowing strength across all the data when providing individual estimates. More specifically, estimates shrink toward overall mean effect and away from the observed value to the extent that local sample sizes are smaller; they move away from the mean toward the observed value when sample sizes are larger. As in the above example, the degree the results are dependable (i.e., whether validity generalizes) may be determined for any predictor (such as specific cognitive abilities and work styles) that has been frequently used for different occupations for which individual validity studies are available.

Subject Matter Experts

If a job requires a lot of manual heavy lifting, one might reasonably estimate that an employee's physical strength be important for performance. If a job requires a lot of interpersonal interactions, one might estimate that an employee's social skills are important. Thus, it has been determined that the necessary personal characteristics to perform well in a particular occupation are estimable, especially by those with occupation experience or who are experts in comparing different occupations (e.g., I/O psychologists). Concerning the latter, Schmidt, Hunter, Croll, and McKenzie (1983, “Estimation of employment test validities by expert judgment”) found that the validity estimates from one SME was equivalent to a local validity study based on data from 92 employees. Furthermore, the validity estimate from four SMEs was equivalent to a local study based on data from 326 employees. Not surprisingly, in a follow up study, Hirsh, Schmidt and Hunter (1986) established that expert raters do a better job at this than less experienced judges, emphasizing the importance of choosing qualified SMEs.

Moderator Research

Occupational characteristics impact the strength of correlation between a predictor and criterion. For example, the correlation between cognitive abilities and overall occupation performance is known to be stronger in occupations that are more complex (Hunter & Hunter, 1984). The type of work to be done should largely determine the type of human characteristics (such as cognitive abilities and work styles) needed to perform the job successfully. A priori knowledge of such factors is a basis of synthetic validity, allowing determination of the importance or irrelevance of a predictor.

To this end, to build a general synthetic validity testing system that can apply to any occupation and obviate the need to conduct and rely on unreliable, small-sample validity studies within local business settings, the present embodiments may be used in accordance with the U.S. Department of Labor's O*NET database. O*NET is an extensive database and framework of occupational characteristics that has been developed, refined, and extended for over 15 years. O*NET remains our country's primary source of continuously updated occupational information. As noted by Oswald et al., (2010), “it is mandatory that any large synthetic validity database be tied to the O*NET.” Similarly, as noted by Steel et al., (2010), “Adding a synthetic validity component to O*NET seems like a logical step.”

Research on O*NET indicates that Generalized Work Activities (GWA) and Work Context are critical occupation characteristics to understanding what moderates validity coefficients. As the name implies, GWAs are descriptions of behavior—essentially broad task statements—that are applicable across a wide range of occupations (e.g., coaching others, filing documents, prioritizing work). Existing data-reduction techniques (principal component analysis with varimax rotation) indicate that these GWAs can be represented by the well-established occupation characteristic dimensions of Data, People, and Things (Fine & Cronshaw, 1999; Gibson, Harvey, & Quintela, 2004; Glomb, Kammeyer-Mueller, & Rotundo, 2004). According to this framework, Data focuses on problem solving and dealing with information (e.g., “thinking creatively”); People focuses on interpersonal relations (e.g., “training and teaching others”); and Things involves physical manipulation (e.g., “handling and moving objects”). Similarly, two Work Context variables have been established as important moderators: Constraints and Consequences (Judge & Zapata, 2015). Constraints, also known as situational strength, reflects the degree to which people tend to have or lack autonomy in given occupations. Consequences reflects whether the outcomes of employees' actions are consequential (such as life or death or financially costly).

Synthetic Validity: Gathering Data

The present embodiments combine the three concepts explained above—validity generalization, SME estimation, and O*NET moderators—to create a novel method of achieving synthetic validity and solve challenge (a) described in The Innovation section, thus establishing an equation that can predict the validity coefficient of a predictor against overall occupation performance, based on the characteristics of that occupation.

Validity generalization is based on the estimation of credibility intervals, the range of performance-predictor associations or validity coefficients observed across all previous validity studies (after accounting for statistical artifacts such as sampling error variance). By sampling across a broad range of occupations, a 95% credibility interval captures the range within which the present methods may define most validity coefficients for additional occupations. To ensure appropriate credibility intervals have been generated, the present embodiments may draw upon the new and innovative metaBUS databases (www.metabus.org). Based on approximately 800,000 correlations, it is the largest summary of management and applied psychology research and provides customized meta-analytic summaries.

Reliable SME estimation requires SMEs with extensive background and training in the areas of personnel selection and psychometrics. The present embodiments were validated by recruiting nine industrial/organizational psychologists with such experience and provided rigorous training on the use of the system. This training included two videos, one on the basics of synthetic validity and another that covers what is required by the SMEs in detail. Accordingly, it was verified that the training and had SMEs check their understanding of the basic concepts. On a scale of one to five, they achieved on average a 4.89 in understanding validity coefficients and 4.44 in understanding credibility intervals. Additionally, information on the five key occupation characteristics that moderate validity coefficients (i.e., Data, People, Things, Constraints and Consequences) were generated. The SMEs were asked to estimate the validity coefficient for an occupation in which each of these five job characteristics is one standard deviation above the mean. Given a linear relationship between two variables, it is mathematically impossible for a one standard deviation (SD) increase in one variable to result in more than one standard deviation increase in another. As such, one embodiment may restrict SMEs from choosing values outside of the ˜68% credibility interval of the validity coefficient.

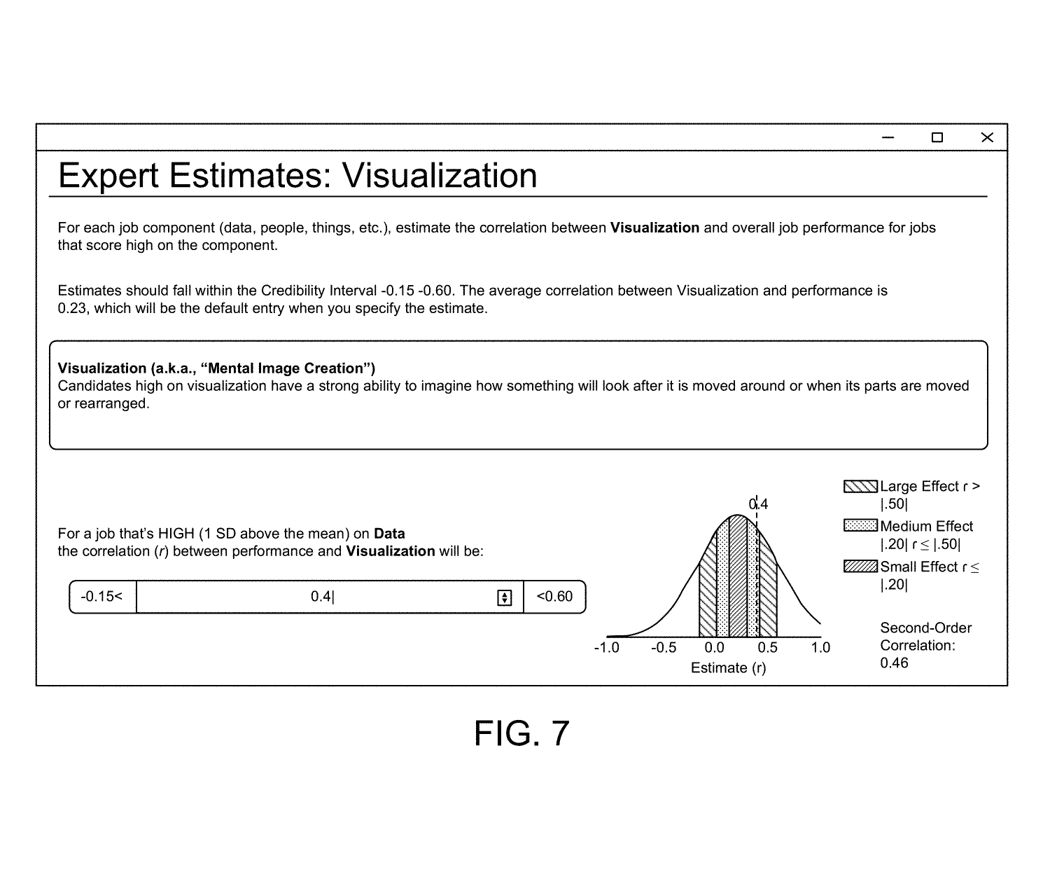

FIG. 7 shows one embodiment of a web interface that SMEs may used, where in this case, the occupational characteristic is Data, and SMEs are asked the extent to which high Data occupations moderate the validity for visualization (the predictor) predicting overall occupation performance (the criterion across all validity coefficients). SMEs estimates appear on the graph in real-time, along with expected relationship strength. The red shading helps SMEs to understand how strongly the validity estimate they provide departs from the typical (mean) validity across occupations (i.e., how strong of a moderator effect they are positing for occupations with a given characteristic). These shadings are based on Cohen's (1998) well-known rule-of-thumb standards for small, medium, and large effects.

The validity estimate entered by the SME between r=−0.15 and r=0.60 is converted into a standard score (z-score) and displayed to the right of the bell curve as a standardized second-order correlation, which is the correlation between validity and the entire range of the occupational characteristic. That is, the single validity estimate for being HIGH on the occupational characteristic indicates the (second-order) correlation is between all validity estimates and the full range of the occupational characteristic. This second-order correlation is estimated on the basis of all SMEs' input and drives the engine for estimating validities across all occupations.

Although the interface shown in FIG. 7 is represented as a web interface, alternative embodiments may exist. For example, the user interface may include a mobile app, customer stand-alone desktop application, or the like. One of ordinary skill may recognize a variety of alternative interface embodiments. Similarly, the user control may include a slider control, a selectable radio control, a dropdown control, a data entry field, a wheel control, or the like. The user input control may be limited to entries within a range of r=−0.15 and r=0.60. Alternative ranges may be used, depending on the specific data used, desired weighting factors, or expansion/retraction of the range requirements. In another alternative embodiment, the bell curve may be replaced with other graphical representations, such as linear graphs with labels indicating correlation ratings, textual representations, or the like.

Synthetic Validity: Checking the Data/Preliminary Results

We gathered SME estimates for each validity coefficient in our existing, O*NET-based testing system of 16 work styles and 17 cognitive abilities (predictors), asking SMEs to estimate the validity of each of these predictors for occupations that are HIGH (1 SD) on Data, People, Things, Constraints, and Consequences (for a total of 33×5=165 estimates). There are three type of checks on the quality of the validity estimates provided. First, the SME may self-assess their level of confidence in their estimates, finding it to be a four on a five-point scale. Second, inter-rater reliability may be assessed, the degree to which raters converge on the same estimate. Note that to assist in rater convergence, the validity generalization procedure already constrains the estimates to what extant research to-date indicates is feasible. The intra-class correlation using a two-way random effect model (where both rater and measure effects are random) was high, equal to 0.90. Another index of inter-rater reliability, directional reliability, is difference from the mean score, in which raters are penalized for responses on either side of the mean. In other words, if some estimated occupation characteristics would increase validity coefficients and other decreased them, a low reliability may result. This proved not to be a problem, with the intra-class correlation of 0.824. Thus, although there may be some variation regarding how the occupational characteristics are rated, there is a very high level of inter-rater reliability.

Third, results may be compared with the preliminary findings of Judge and Zapata (2015) and Steel et al. (2006), all of whom investigated how O*NET occupation characteristics data moderate validity coefficients. Together, these studies should indicate two things. First, validity coefficients should be higher when Consequences are stronger and lower when Constraints are stronger. Second, validity coefficients should be higher when there is a match between the type of predictor and the type of task; specifically, when the Data occupational characteristic is high, cognitive predictors should be more important, when the People occupational characteristic is high, social skill predictors should be more important, and when the Things occupational characteristic is high, spatial and perceptual predictors should be more important. Our results aligned with these expectations. Specifically, our analysis shows that occupations one standard deviation higher in Consequences were estimated to have validities approximately 0.06 higher. By contrast, jobs one standard deviation higher in Constraint were estimated to have validities that were 0.045 lower. Validity coefficients for cognitive ability predictors (e.g., Analytical Thinking) were estimated to increase 0.13 when Data was high, compared to an average of no increase when People or Things were high. Validity coefficients for social skill predictors (e.g., Cooperation) were estimated to also increase by 0.13 when people was high, compared to an average drop of 0.05 when Data or Things were high. Finally, validity coefficients for perceptual and spatial predictors (e.g., Visualization) were estimated to increase by 0.06 when Things were high, with on average no change when Data or People were high. We thus conclude that our system works as hypothesized.

Synthetic Validity: Crunching the Data

To build synthetic validity and create an equation to estimate the validity coefficient of a predictor (e.g., Visualization) based on the combination of the five characteristics of an occupation, to create a matrix as shown in the table below.

| | Visualization Validity | | | | | |
|---|---|---|---|---|---|---|
| Visualization | | Data | People | Things | Constraints | Consequences |
| Validity | Coefficient | (J1) | (J2) | (J3) | (J4) | (J5) |
| Coefficient | 1 | 0.23 | −0.15 | 0.27 | −0.22 | −0.01 |
| Data (J1) | 0.23 | 1 | 0.61 | −0.09 | −0.53 | 0.42 |
| People (J2) | −0.15 | 0.61 | 1 | −0.22 | −0.59 | 0.47 |
| Things (J3) | 0.27 | −0.09 | −0.22 | 1 | 0.34 | 0.36 |
| Constraints (J4) | −0.22 | −0.53 | −0.59 | 0.34 | 1 | −0.03 |
| Consequences | −0.01 | 0.42 | 0.47 | 0.36 | −0.03 | 1 |
| (J5) | | | | | | |

The first column in the above matrix shows the correlations from the SME ratings. These are the correlations between the validity coefficient (between the predictor and overall occupation performance) and occupation characteristics-second-order correlations expressed in a standard format as z-scores. These are the correlations that change based on the occupation and the predictor. The correlations in white cells have been derived from the O*NET database of 954 occupations. They are stable as they simply represent the associations among the occupation characteristics.

Each predictor used in the pre-employment testing system has its own matrix similar to the one shown above. We can convert the above matrix into a predictive equation using ordinary least squares multiple regression on a correlation matrix. The weights B are derived by the usual B=inv(Rxx)*Rxy, where Rxx is the p×p matrix of occupational characteristics, and Ryy is the p×1 vector of second-order correlations. Given the above, then

Validity coefficient (between Visualization and Overall Occupation Performance)=0.37·J1+−0.54·J2+0.36·J3+−0.46·J4+−0.06·J5 (1)

Using this predictive equation based on occupation characteristics (converted to z-scores), in can be inferred that the validity coefficient for an occupation.

The five occupation characteristics Data, People, Things, Constraints, and Consequences have been derived by: Conducting a Principal Component Analysis (PCA) on O*NET Generalized Work Activities (GWAs) using varimax rotation. We selected the top three components, but only selected GWAs with low cross-loadings in order to prevent multicollinearity. We selected the scales for Constraints and Consequences from Meyer et al. (2009), although items with high cross-loadings may be removed.

This resulted in the following items from O*NET for each of the five occupation characteristics:

Data: All the items (total of 9) in this occupation characteristic were derived from O*NET GWAs. The Cronbach's alpha (reliability coefficient) for a unit weighted scale is 0.95. Mean is 3.70 with a standard deviation of 0.88. Example Items: Analyzing Data or Information, Documenting/Recording Information, Estimating the Quantifiable Characteristics of Products, Events, or Information

People: All the items (total of 8) in this occupation characteristic were derived from O*NET GWAs. The Cronbach's alpha (reliability coefficient) for a unit weighted scale is 0.88. Mean is 3.18 with a standard deviation of 0.82. Example Items: Assisting and Caring for Others, Resolving Conflicts and Negotiating with Others, Selling or Influencing Others.

Things: All the items (total of 8) in this occupation characteristic were derived from O*NET GWAs. The Cronbach's alpha (reliability coefficient) for a unit weighted scale is 0.929. The mean is 2.44 with a standard deviation of 1.13. Example Items: Controlling Machines and Processes, Drafting, Laying Out, and Specifying Technical Devices, Parts, and Equipment, Handling and Moving Objects

Constraints: Only the first item in this occupation characteristic was derived from O*NET GWAs. The rest (5 items) were derived from O*NET Work Context. The Cronbach's alpha (reliability coefficient) for a unit weighted scale is 0.68. Mean is 2.49 with a standard deviation of 0.46. Example Items: Thinking Creatively*, Freedom to Make Decisions*, Importance of Repeating Same Tasks. (Note: * means item is Reversed Scored)

Consequences: Only the first item in this occupation characteristic was derived from O*NET GWAs. The rest (5 items) were derived from O*NET Work Context. The Cronbach's alpha reliability coefficient) for a unit weighted scale is 0.68. Mean is 3.43 with a standard deviation of 0.44. Example Items: Monitoring and Controlling Resources, Responsibility for Outcomes and Results, Responsible for Others' Health and Safety

To calculate the validity coefficient of a predictor for an existing O*NET occupation, first obtain the mean level ratings for each of the five occupation components. For example, for the O*NET occupation Agricultural Engineers, calculate the mean level rating from the data in O*NET and then converted them into a standard score (z-score). This resulted in the values 1.53, 1.14, 0.94, 0.77, −1.30 for Data, People, Things, Constraints, and Consequences respectively. We then estimate the validity coefficient between Visualization and overall occupation performance for Agricultural Engineers as (0.37)*1.53+(−0.54)*1.14+(0.36)*0.94+(−0.46)*0.77+(−0.06)*(−1.30))=0.012.

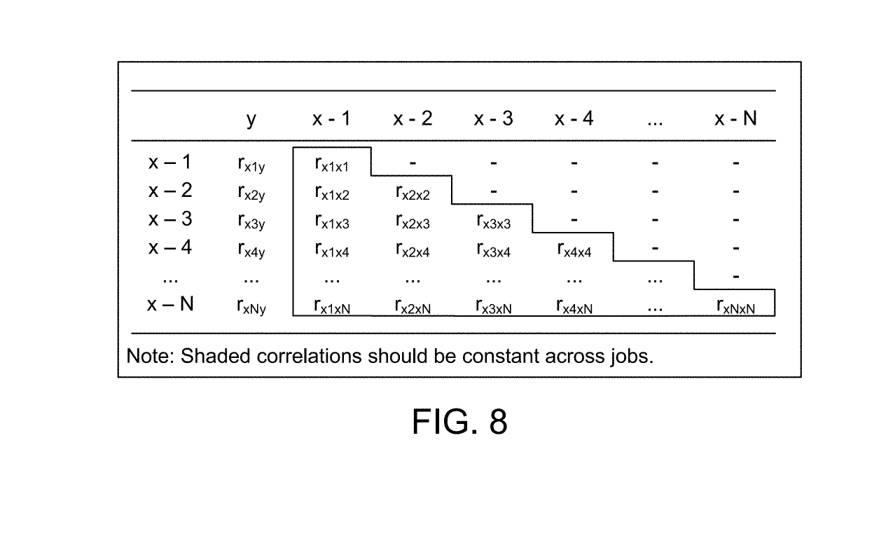

For a new occupation not in the O*NET database, survey software in which employees and supervisors provide the level ratings for each of the nine items under the Data characteristic may be used. In one embodiment, the survey may include, eight items under People, eight items under Things, six items under constraints, and six items under consequences. Based on these responses, the mean level rating for each of these five occupation characteristic may be calculated. One embodiment may then calculate the standard score (z-score) for each of the five occupation characteristics and use these five z-scores to calculate the validity coefficient. FIG. 8 shows correlations of validity correlations by job.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
storing a predetermined set of personnel tests in a database;
determining a correlation indicator, the correlation indicator defining a strength of correlation between an aspect of at least one of the personnel tests and a measure of job performance, wherein the correlation indicator is determined in response to validation information provided by one or more subject matter experts; and
automatically building a custom personnel evaluation in response to the correlation indicator.

2. The method of claim 1, further comprising collecting correlation information from a plurality of subject matter experts, the correlation information indicative of a correlation between test performance and job performance in a specified job.

3. The method of claim 2, further comprising determining a correlation coefficient for each test, the correlation coefficient being calculated in response to the correlation information collected from the subject matter experts.

4. The method of claim 3, further comprising ranking the tests according to the correlation coefficient for each job in the set of jobs.

5. The method of claim 4, further comprising storing a time period required for a test taker to complete each test.

6. The method of claim 5, further comprising receiving a testing time limit for a particular personnel evaluation test.

7. The method of claim 6, further comprising automatically building a custom personnel evaluation test in response to the rank, the testing time limit, and the time periods.

8. A system, comprising:
a data storage device configured to store a predetermined set of personnel tests in a database; and
a data processor coupled to the data storage device, the data processor configured to:
determine a correlation indicator, the correlation indicator defining a strength of correlation between an aspect of at least one of the personnel tests and a measure of job performance, wherein the correlation indicator is determined in response to validation information provided by one or more subject matter experts; and
automatically build a custom personnel evaluation in response to the correlation indicator.

9. The system of claim 8, the data processor further configured to collect correlation information from a plurality of subject matter experts, the correlation information indicative of a correlation between test performance and job performance in a specified job.

10. The system of claim 9, the data processor further configured to determine a correlation coefficient for each test, the correlation information being calculated in response to the correlation information collected from the subject matter experts.

11. The system of claim 10, the data processor further configured to rank the tests according to the correlation coefficient for each job in the set of jobs.

12. The system of claim 11, the data processor further configured to store a time period required for a test taker to complete each test.

13. The system of claim 12, the data processor further configured to receive a testing time limit for a particular personnel evaluation test.

14. The system of claim 13, the data processor further configured to automatically build a custom personnel evaluation test in response to the rank, the testing time limit, and the time periods.

15. A system, comprising:
a user interface configured to present a prompt for evaluating an aspect of at least one personnel test and job performance;
a user control for receiving an assignment of a correlation indicator for defining a strength of correlation between the aspect of the at least one personnel test and a measure of job performance; and
a communication interface for communicating the assignment of the correlation indicator to a database of correlation indicators associated with a predetermined set of one or more personnel tests.

16. The system of claim 15, wherein the user control comprises a selectable graphical control displayed on the user interface.

17. The system of claim 15, wherein inputs to the user control are limited to entries that fall within a range of a credibility interval.

18. The system of claim 17, wherein the credibility interval is between −0.15 and 0.60.

19. The system of claim 18, wherein the credibility interval is displayed on a graphical representation of a statistically curved distribution of correlation indicators.

20. The system of claim 19, wherein the graphical representation includes indicators of inputs that represent high, medium, and low correlation.
